(19) United States
(12) Patent Application Publication
(10) Pub. No.: US 2008/0031997 A1
(43) Pub. Date: Feb. 7, 2008

(54) INJECTOR FOR INJECTION MOULDING EQUIPMENT OF PLASTIC MATERIALS

(75) Inventors: Maurizio BAZZO, Oderzo (Treviso) (IT); Tiziano BOSCARIOL, Cessalto (Treviso) (IT)

Correspondence Address: HESLIN ROTHENBERG FARLEY & MESITI PC, 5 COLUMBIA CIRCLE, ALBANY, NY, 12203, US

(73) Assignee: INGLASS S.p.A., San Polo di Piave (Treviso) (IT)

(21) Appl. No.: 11/627,698

(22) Filed: Jan. 26, 2007

(30) Foreign Application Priority Data
Jan. 27, 2006 (IT) TO2006A000057

(51) Int. Cl. B29C 45/20

(52) U.S. Cl. 425/562; 239/86; 264/349

(57) ABSTRACT

Described herein is an injector for equipment for injection moulding of plastic materials, in which the open/close end of the plug and the corresponding axial passage of the nozzle tip have each an oblong shape in cross section.

### CROSS-REFERENCE TO RELATED APPLICATIONS

This application claims priority from Italian patent application No. TO2006A000057, filed on Jan. 27, 2006, the entire disclosure of which is incorporated herein by reference.

### FIELD OF THE INVENTION

The present invention relates in general to the moulding of plastic materials and more in particular regards an injector for equipment of this sort and a moulding method that uses said injector.

Traditionally, injectors for equipment for moulding plastic materials include a hollow body having a tubular nozzle tip, which defines an axial passage for introduction of the fluid plastic material into a mould. A plug, which is coaxially mobile within the body, has an open/close end co-operating with the passage of the nozzle tip, and actuator means are provided for governing the axial displacement of the plug between an advanced position and a retracted position, in which said open/close end closes and opens, respectively, flow through the passage of the nozzle tip.

### STATE OF THE PRIOR ART

In the current state of the art, the moulding of components made of plastic material with the use of injectors of the type defined above, described and illustrated, for example, in the documents Nos. EP-B-1277560 and EP-B-1321274, can be carried out, setting the injector directly on the shape being formed (i.e., with the nozzle tip directly fitted on the mould), or else via a cold runner and injector situated on the outside of the shape being formed.

The first type enables quite a good aesthetic appearance of the moulded piece to be obtained, even though the witness mark left at the point of injection remains clearly on the piece itself, and prevents any waste of material due to the presence of cold runners. The second system prevents any sign of injection on the moulded piece, but involves higher costs due to the elimination of the material present within the cold runners.

The above situation is particularly marked in the case of particular articles, such as, for example, the transparent lenses of the front and rear lights of motor vehicles, where a particularly good aesthetic appearance and extremely high optical properties are required and where the moulded material (typically polycarbonate) has a high cost.

FIGS. 8 and 9 of the annexed plate of drawings show, respectively, in elevation and in cross section, a typical lens L made of moulded plastic material for the sector of automobile lighting, consisting of a C-shaped body formed with peripheral ribs N and stiffening ribs R. The lens L is in this case moulded with a conventional shutter injector, i.e., in which the open/close end of the plug and the corresponding passage of the nozzle tip have a circular cross section. In the case where the lens is moulded using the first methodology described above, the corresponding injection witness mark T, which evidently also has a circular shape, remains clearly visible on the body C of the lens L, with an unsatisfactory aesthetic effect. To prevent this, it would thus be necessary to mould the lens with the second methodology described above, accepting, however, the corresponding drawbacks.

### SUMMARY OF THE INVENTION

The object of the present invention is to enable moulding of lenses of this sort, or similar injected articles, without recourse to cold runners, but causing the injection witness mark to be set in a position corresponding to a part of the article in which it does not lead to drawbacks of an aesthetic nature.

According to the invention, the above object is achieved thanks to the fact that the aforesaid open/close end of the plug and the passage of the nozzle tip have an oblong shape in cross section.

Thanks to said shape, which may for example be rectangular or else oval or elliptical, the injector can be set in a position directly corresponding to a part of the article to be moulded that is not readily visible or in any case where the corresponding aesthetic appearance is not adversely affected. In the case of the lens represented in FIGS. 8 and 9, said part may consist of the peripheral rib N or the stiffening rib R in view of the fact that the injection witness mark, given its oblong shape according to the invention, may be contained within the restricted dimensions of said ribs.

In order to ensure, in operation proper, coupling between the open/close end of the plug and the passage of the nozzle tip, there may conveniently be provided angular centring means for centring the plug itself, provided, for example, inside or outside the body of the injector.

The subject of the invention is also a method for injection moulding of articles made of plastic material using at least one injector having the characteristics defined above.

### BRIEF DESCRIPTION OF THE DRAWINGS

The invention will now be described in detail with reference to the annexed plate of drawings, which is provided purely by way of non-limiting example and in which:

FIG. 1 is a schematic view in axial cross section of an injector for injection moulding of plastic materials according to the invention;

FIG. 2 is a perspective view in cross section, at an enlarged scale and according to a first angle, of a part of the injector of FIG. 1;

FIG. 3 is a view similar to that of FIG. 2 according to a different angle;

FIG. 4 is a cross-sectional view, which shows the detail of FIGS. 2 and 3 during the step of injection;

FIG. 5 is an exploded and partial perspective view of a variant of the injector of FIGS. 1 to 4;

FIG. 6 is a view similar to that of FIG. 4 but at an enlarged scale, which shows a second variant of the injector according to the invention;

FIG. 7 is an exploded perspective view, sectioned and at a reduced scale, of the injector of FIG. 6;

FIG. 8 is a schematic view in elevation of an injection-moulded article, for making which use of the injector according to the invention is particularly advantageous; and

FIG. 9 is a cross-sectional view according to the line IX-IX of FIG. 8.

### DETAILED DESCRIPTION OF THE INVENTION

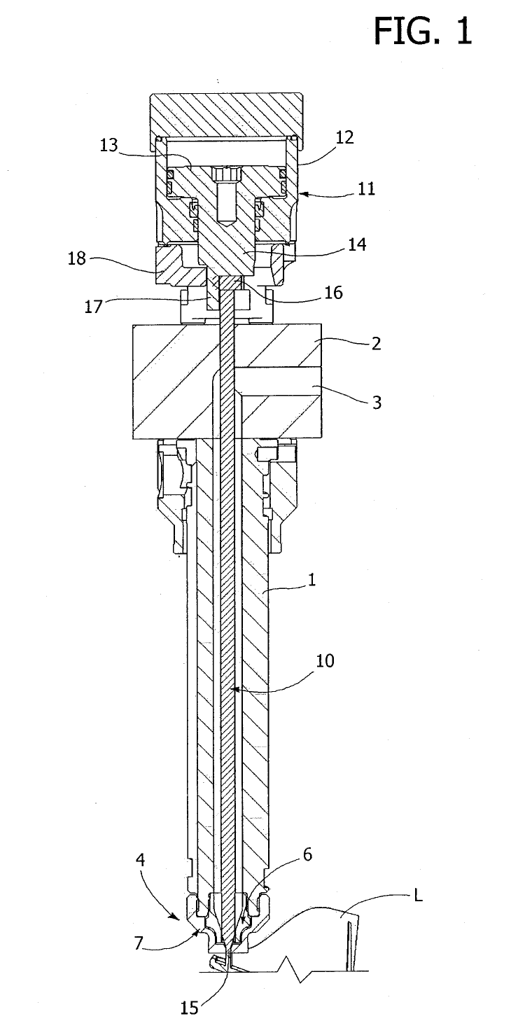

With initial reference to FIG. 1, an injector for injection moulding of plastic materials according to the invention basically comprises a tubular body 1 applied, in the case of the example illustrated, underneath a hot-chamber arm 2 provided with a pipe 3 for supply of the fluid plastic material to be injected.

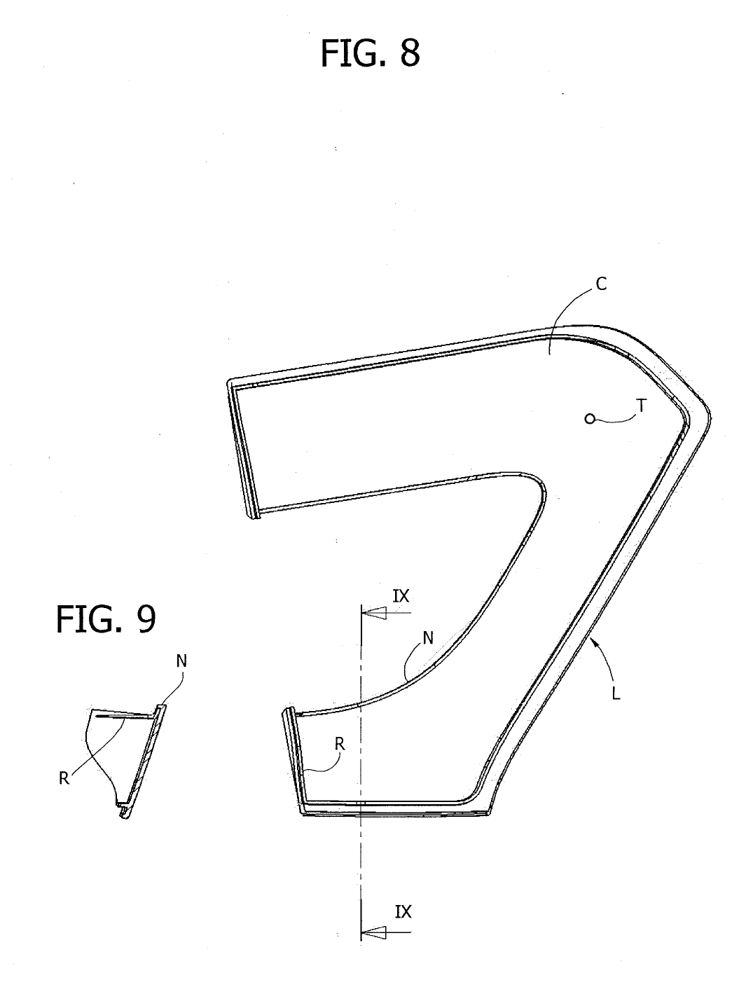

Applied at the bottom end of the body 1 is a nozzle tip 4, through which the plastic material is injected directly into the cavity of a mould (not illustrated), for example, shaped for moulding the lens L described previously with reference to FIGS. 8 and 9.

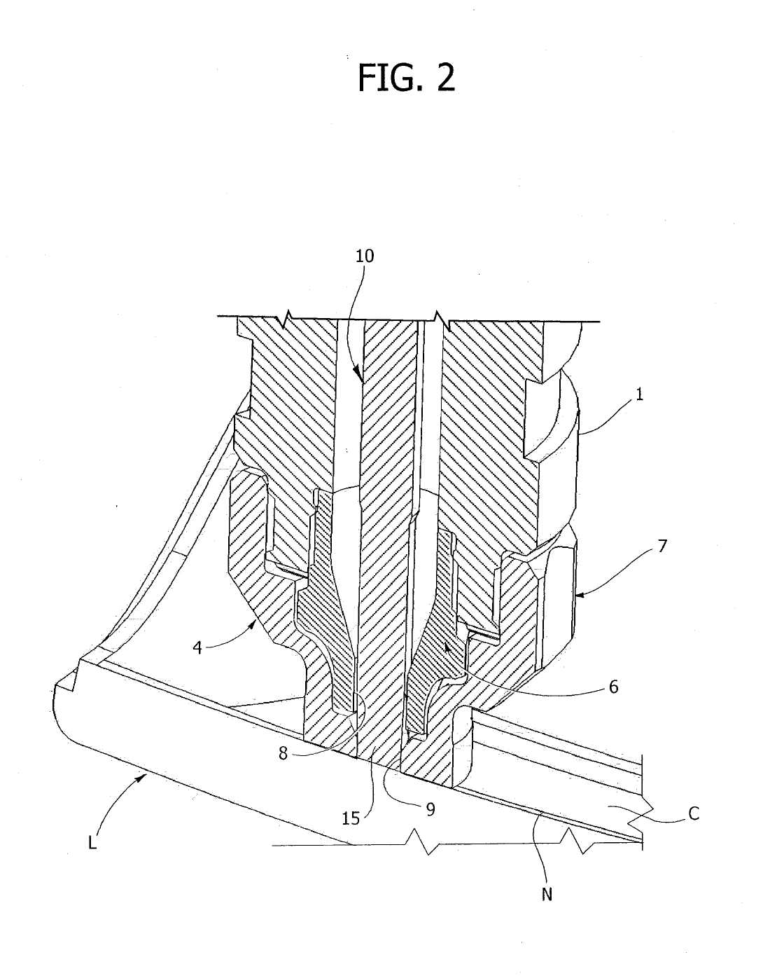

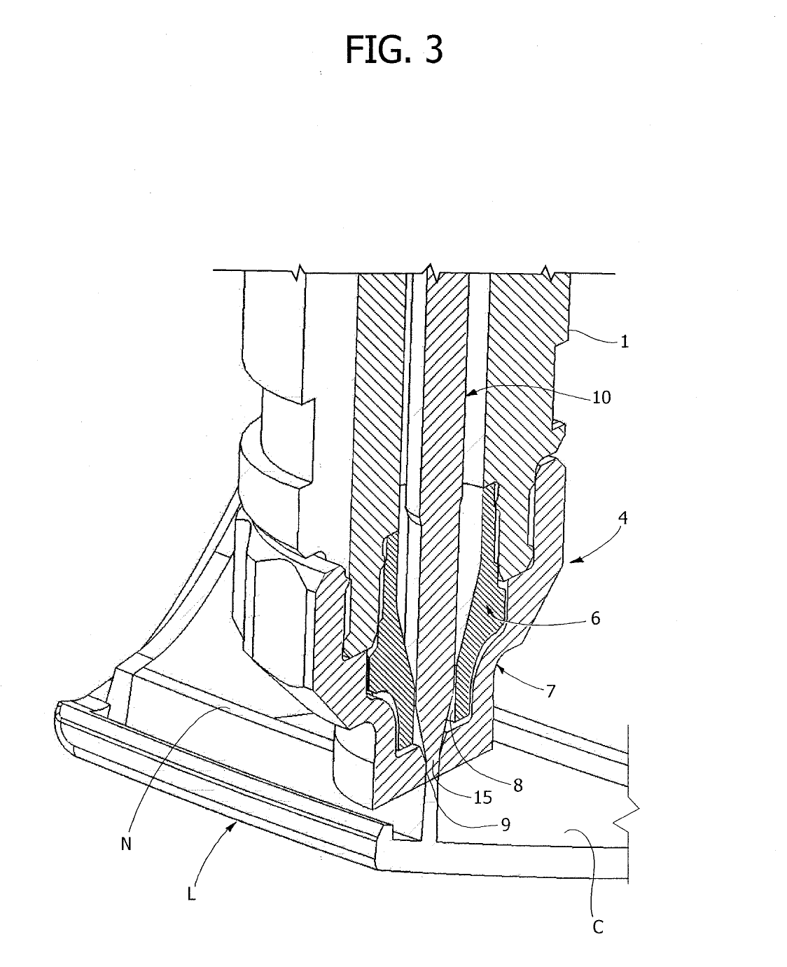

The nozzle tip 4 comprises in a way generally known (for example, from the already cited document No. EP-B-132174) an internal hollow element or prod 6, normally made of a material with high thermal conductivity, and an external hollow element or threaded ring 7 normally made of a material with lower thermal conductivity. As may be seen more clearly in FIGS. 2 to 4, the ring 7 and the prod 6 are connected, independently of one another, to the end of the body 1, via respective threaded couplings.

The nozzle tip 4 defines an axial passage for introduction of the fluid plastic material from the cavity of the body 1 into the mould. Said axial passage is defined (FIGS. 2 to 4) by a restricted end opening 8 and by a corresponding restricted end opening 9 of the prod 6 and of the ring 7, respectively.

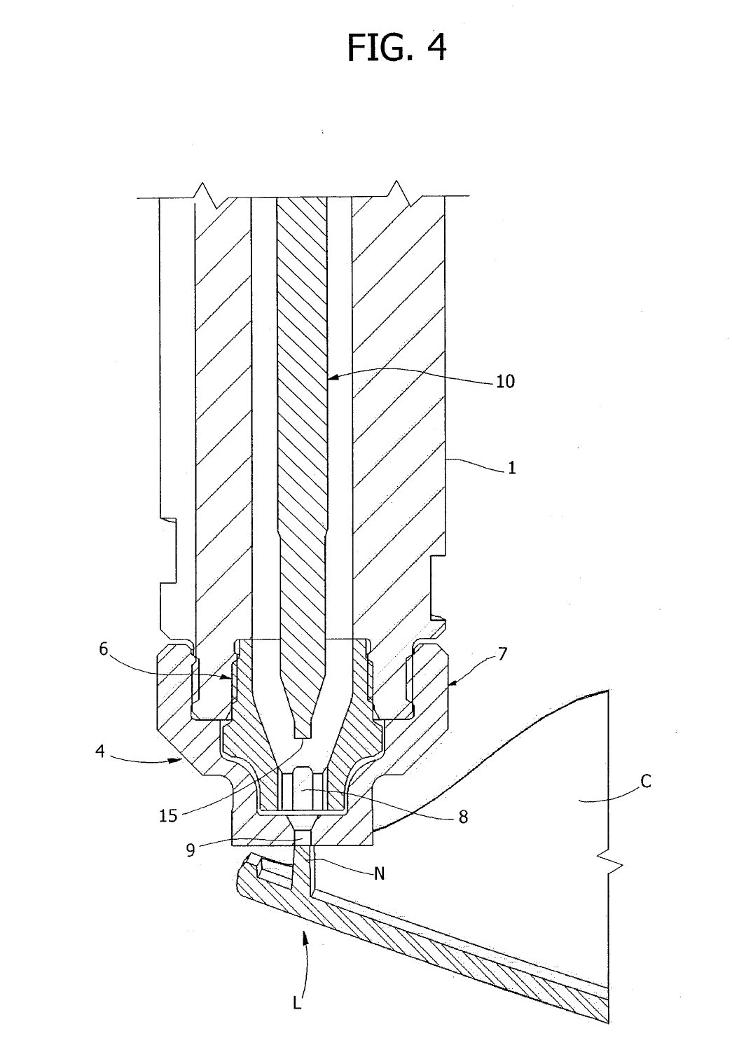

The flow of the plastic material through the axial passage 8-9 is controlled in a generally conventional way by means of a plug 10, which extends coaxially through the cavity of the body 1 and is displaceable, in the way clarified in what follows, between an advanced position for closing the passage 8-9 (represented in FIGS. 1 to 3), and a retracted position for opening said passage (represented in FIG. 4).

The displacement of the plug 10 between the advanced position and the retracted one is governed, also in a conventional way, via an actuator 8 (FIG. 1), constituted, in the case of the example illustrated, by a linear fluid actuator 11. In this case, the actuator 11 comprises a cylinder 12 and a piston 13 with a stem 14, connected to which is—with the modalities clarified in what follows—the top end of the plug 10.

Traditionally, the plug 10 has a cylindrical shape with circular cross section, with the bottom end tapered (as illustrated in the already cited documents Nos. EP-B-1277560 and EP-B-1321274). Accordingly, also the axial passage defined by the openings 8 and 9 of the prod 6 and of the ring 7, respectively, has a circular cross section. According to the basic characteristic of the invention, the bottom end of the plug 10, designated by 15 and defining the open/close element of the injector, has an oblong shape in cross section, for example, rectangular as in the case of the example illustrated, or else elliptical or oval. Also the opening 9, as possibly (albeit not necessarily) the opening 8 of the axial passage of the nozzle tip 4, has an oblong shape in cross section, complementary to that of the open/close end 15 of the plug 10.

Thanks to said shape, the injection of the plastic material by the injector within the mould can be performed in a point corresponding to an area of the article to be moulded that is of no importance as regards the overall aesthetic appearance of said article, i.e., in an area where the witness mark of the point of injection will not be immediately identifiable. In the case of the specific example described previously with reference to FIGS. 8 and 9, i.e., of the lens L for lighting devices of motor vehicles, the oblong open/close end 15 of the plug 10, may, for example, be set in a position corresponding to the area of the peripheral rib N, in the way clearly visible in FIGS. 2 to 4. Said oblong open/close end 15 is in this case comprised within the transverse and longitudinal dimensions of said peripheral rib N.

In order to position the plug 10 angularly within the body 1 so that the open/close end 15 is properly aligned and centred with respect to the opening 9, which is in turn centred with respect to the opening 8 via the reciprocal angular positioning of the ring 7 and of the prod 6, the invention envisages different alternatives. In the case of the embodiment represented purely by way of example in FIG. 1, the centring system is provided on the outside of the body 1 and more in particular in a position corresponding to the actuator 11: in this case, the top end of the plug 10 has a prismatic head 16 fitted to a corresponding prismatic part 17 of the piston 14, which is in turn locked in rotation via a bracket 18.

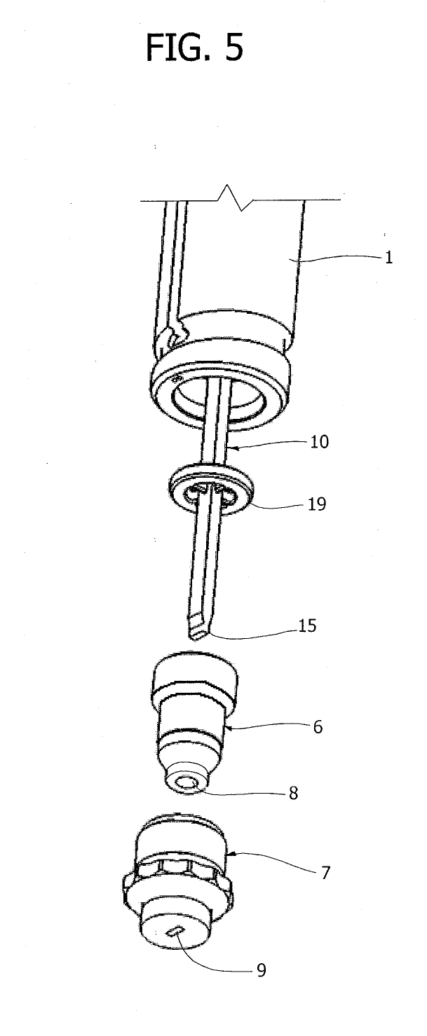

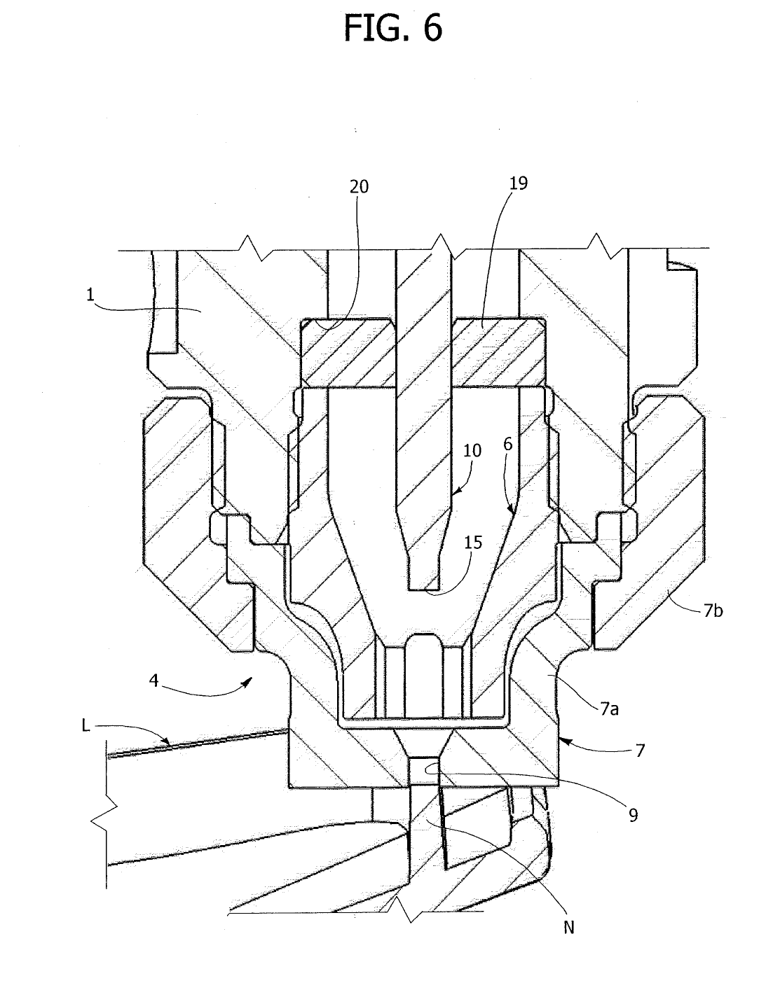

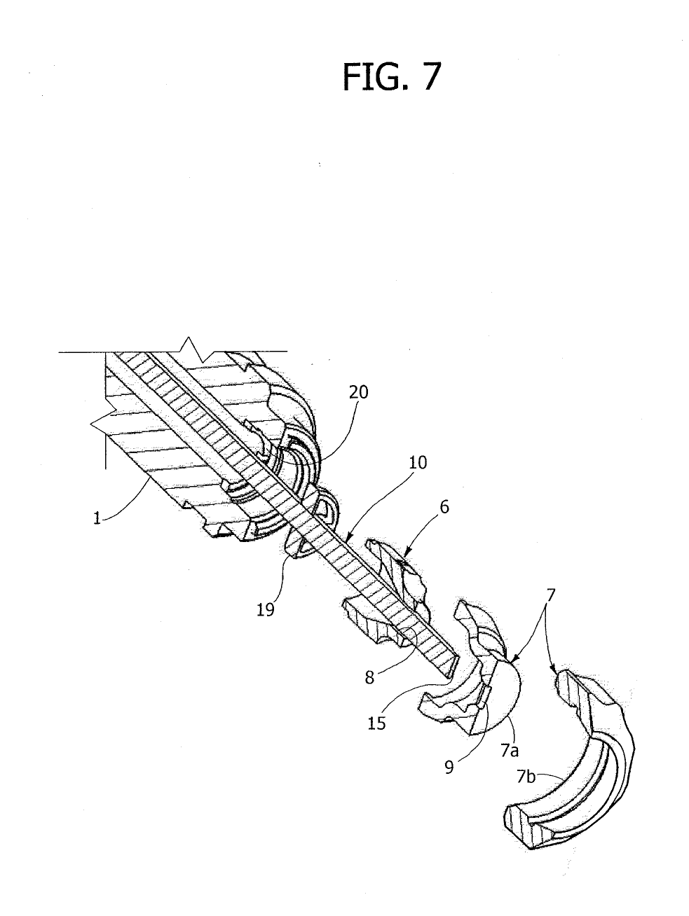

In the case of the variants represented, respectively, in FIG. 5 and in FIGS. 6-7 (in which parts that are identical or similar to the ones already described previously are designated by the same reference numbers), the angular centring system for the plug 10 is provided within the body 1, and can consist of a ring with radial fins 19, for example, locked axially and angularly between the top of the prod 6 and an internal annular shoulder 20 of the body 1.

In this case, at least the axial portion of the plug 10 that is mobile through the ring 19 will have a prismatic configuration, for example, with quadrangular cross section.

In the case of the variant represented in FIGS. 6 and 7, the ring 7 is formed in two parts 7a and 7b.

Of course, the details of construction and the embodiments may vary widely with respect to what is described and illustrated herein, without thereby departing from the scope of the present invention as defined in the ensuing claims.

1. An injector for equipment for injection moulding of plastic materials, including a hollow body having a nozzle tip defining an axial passage for the introduction of fluid plastic material into a mould, and a plug coaxially mobile within the body and having an open/close end co-operating with said passage of the nozzle tip, and actuator means for governing axial displacement of said plug between an advanced position and a retracted position, in which said open/close end closes and opens, respectively, the flow through said passage of the nozzle tip, and wherein said open/close end of said plug and said passage of said nozzle tip have an oblong shape in cross section.

2. The injector according to claim 1, wherein said cross section is generally rectangular.

3. The injector according to claim 1, wherein said cross section is generally elliptical or oval.

4. The injector according to claim 1, further including angular centering means for centering said open/close end of said plug with respect to said passage of said nozzle tip.

5. The injector according to claim 4, wherein said angular centering means are situated on the outside of said body.

6. The injector according to claim 4, wherein said angular centering means are set within said body.

7. The injector according to claim 6, wherein said angular centering include a ring locked within said body via said nozzle tip.

8. A method for injection moulding of articles of plastic material via a mould and at least one injector according to claim 1, in which said article has a marginal part in the form of a ribbing, wherein said open/close end with oblong shape of said plug is positioned with respect to the mould at an area corresponding to that of said marginal part of said article to be moulded.
